(19) United States
(12) Patent Application Publication
(10) Pub. No.: US 2023/0235985 A1
(43) Pub. Date: Jul. 27, 2023

(54) Bore Cleaning Apparatus And Methods For Firearms

(71) Applicant: Terry Sanders, Knoxville, TN (US)

(72) Inventor: Terry Sanders, Knoxville, TN (US)

(21) Appl. No.: 18/149,962

(22) Filed: Jan. 4, 2023

Related U.S. Application Data
(60) Provisional application No. 63/267,215, filed on Jan. 27, 2022.

(51) Int. Cl. F41A 29/02; B08B 9/043

(52) U.S. Cl. CPC F41A 29/02; B08B 9/0436; B08B 2209/04

(57) ABSTRACT

A compact apparatus and method for cleaning the bore of a firearm. The bore cleaning apparatus provides for adjustability to accommodate a range of bore diameters and bore cleaning patches. The bore cleaning apparatus also provides for extraction of the apparatus from the bore of a firearm in the event of inadvertent lodging of a cleaning patch in the breech of the firearm. An adjustable loop is provided at a distal end of a length of twine to securely cinch about a cleaning patch. A proximal end of the length of twine is used to draw the cleaning patch through the bore. A shorter second length of twine is secured with the loop to enable extraction of the bore cleaning apparatus in the event the cleaning patch gets lodged within the breech.

### RELATED APPLICATION

This application relates back to U.S. 63/267,215 filed Jan. 27, 2022, and incorporates the filing in its entirety.

### FIELD OF THE INVENTION

The present subject matter relates to firearms, and more particularly to apparatus for cleaning a bore of a firearm.

### BACKGROUND OF THE INVENTION

“Rope” type cleaning apparatus for firearms are available for cleaning the bore of a firearm. However, these other devices merely have a loop in the “rope” that does not secure a cleaning patch properly, nor do they help guide the patches down the bore of the barrel, nor extraction of the patch should it get lodged in the breech. More complex systems do not have the flexibility of multiple firearm calibers nor the compactness to carry complete gun cleaning kits easily.

There is a need for improved apparatus and methods for cleaning the bore of a firearm that is compact, is adjustable, multi-caliber capable and provides a method of easy, inexpensive extraction of the cleaning patches, should they get lodged in the breech of the firearm.

### SUMMARY OF THE INVENTION

The following detailed description is of the best currently contemplated modes of carrying out exemplary embodiments of the invention. The description is not to be taken in a limiting sense but is made merely for the purpose of illustrating the general principles of the invention.

The present subject matter provides a bore cleaning apparatus and method for cleaning a bore of a firearm. The bore cleaning apparatus provides for adjustability to accommodate a range of bore diameters and types of bore cleaning patches. The bore cleaning apparatus also provides for extraction of the apparatus from the bore of a firearm in the event of inadvertent lodging of the cleaning patch in the breech of the firearm.

The bore cleaning apparatus according to aspects of the invention is shown in reference to the drawings of FIGS. 1-11. The bore cleaning apparatus includes a length of a braided twine 10, preferably a white braided nylon. The length of braided twine 10 has a proximal end and a distal end. The length of braided twine 10 has a length greater than a length of the barrel of the firearm to be cleaned.

A knot 12 is defined at the distal end of the length of braided twine 10 to define a loop at the distal end. A sleeve 22 is slidably carried by the loop 14, with the sleeve 22 positioned adjacent to the knot 14. A bead 24 is also slidably carried by the loop 14 distal from the sleeve 22. The sleeve 22 and bead 24 are operable to securely cinch the loop 14 about a cleaning patch 26 inserted into the loop 14. Each of the bead 22 and the sleeve 24 should be selected from a rigid or semi-rigid material to prevent scratching the machined surfaces of the bore.

An aglet 18 is provided at the proximal end of the length of braided twine 10. The aglet 18 is formed of a weighted material, such as a metal, to facilitate passage of the length of braided twine 10 through the bore 28, 30 of the firearms.

In other embodiments, a second length of twine 16 is coupled with a distal end of the loop 14. The second length of twine 16 has a length of 10 inches so that the free end of the second length of twine 16 may be grasped and pulled to extract the bore cleaning apparatus in the event a cleaning patch becomes lodged within the breech.

Each of the length of braided twine 10, the sleeve 22, the bead 23, the aglet 18, and the second length of braided twine 16 have an outer diameter that is less than an inner diameter of the bore 28, 30 of the firearms. Preferably, the outer diameter is selected to allow for easy passage of the bore cleaning apparatus completely through the bore.

In use, a cleaning patch 26 is inserted into the loop 14. The sleeve 22 and the bead 24 are moved to the distal end of the loop 14 to securely cinch the loop 14 about the cleaning patch 26. The proximal end of the length of braided twine 10 is inserted through the breech and completely through the bore. The aglet 18 is selected to have a sufficient weight to draw the length of braided twine 10 completely down through the bore. The aglet 18 and or proximal end of the length of braided twine 10 may then be pulled to draw the cleaning patch 26 through the bore to remove and clean debris and fouling deposits accumulated in the bore.

In the event the cleaning patch 26 becomes lodged within the breech, the second length of braided twine 16 may be grasped and pulled to extract the lodged cleaning patch 26 and apparatus from the bore.

The length and diameter of the braided twine 10 and the second length of braided twine 16 may be varied to be tailored to a rifle barrel 28 and a handgun barrel 30. As will be appreciated selecting the length to a rifle barrel 28 and a diameter to a smaller caliber firearm would permit universal application to a variety of handguns and rifles having varying calibers, while selection of the cleaning patch 26 would adapt the bore cleaning apparatus for universal bore cleaning applications. A length of about 33″ would accommodate most firearms. For smaller caliber bores, the bead 24 may be removed from the loop 14.

In a preferred embodiment, the length of braided twine is approximately 36-inch length of white, braided #36 nylon twine with a 2½-inch loop 14 tied on one end using a noose knot. The second length of braided twine may include a 10-inch length of pink or orange, braided #12 nylon twine tied to the loop 14 using a clinch knot with two wraps. The metallic aglet 18 may be secured with a crimp 20 on the proximal end opposite the loop 14. The sleeve 22 may be a ⅜″ length of clear PVC tubing with an OD of 3/16″ and an ID of ⅛″. The bead 24 is preferably a 6 mm×8 mm opaque bead with a 4 mm diameter hole.

The bore cleaning apparatus of the present invention is very compact, is adjustable, multi-caliber capable and provides a method of easy extraction of the cleaning patches should they get lodged in the breech of the firearm. This apparatus is flexible and adjustable to be part of a 3″×5″ carry bag or pouch. With both cotton patches, scrubber patches, and a cleaner/lubricant/protectant (CLP), in this same bag, it provides a clean firearm barrel.

It should be understood, of course, that the foregoing relates to exemplary embodiments of the invention and that modifications may be made without departing from the spirit and scope of the invention as set forth herein.

### OTHER EMBODIMENTS

Although the present subject matter has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present subject matter.

### DESCRIPTION OF THE FIGURES

FIG. 1 is a perspective view of the bore cleaning apparatus.

FIG. 2 is a perspective view of the bore cleaning apparatus in use.

FIG. 3 is a perspective view of the bore cleaning apparatus.

FIG. 4 is an exploded view of the bore cleaning apparatus.

FIG. 5 is a section view of the bore cleaning apparatus, taken along line 5-5 in FIG. 3.

FIG. 6 is a detailed side view of the bore cleaning apparatus showing a loop adjustment.

FIG. 7 is a detailed side view of the bore cleaning apparatus showing a loop adjustment.

FIG. 8 is a detailed side view of the bore cleaning apparatus showing a loop adjustment.

FIG. 9 is a section view of the bore cleaning apparatus, taken along line 9-9 in FIG. 2.

FIG. 10 is a section view of the invention showing the patch moving through the barrel.

FIG. 11 is a perspective view of an alternate configuration of the bore cleaning apparatus in use.

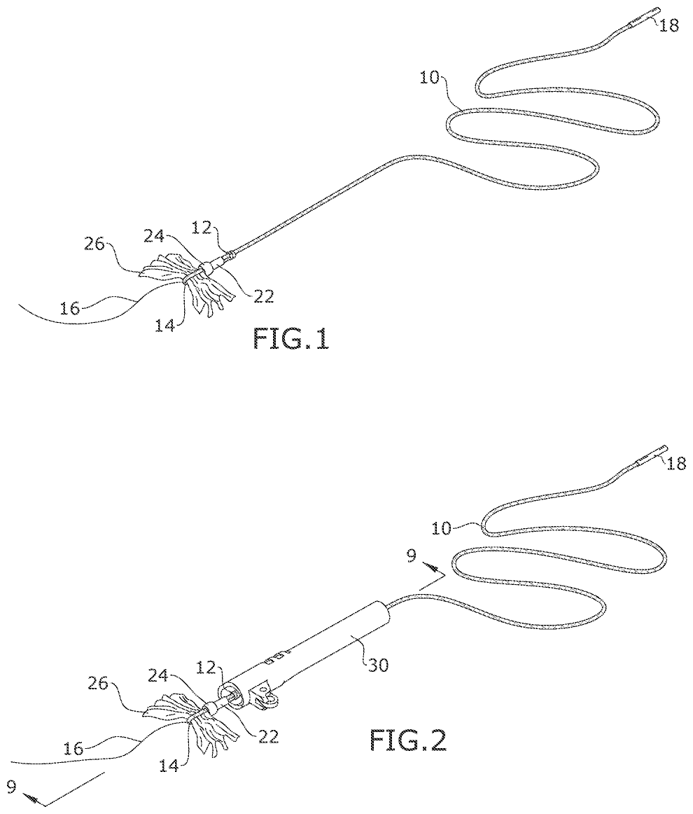

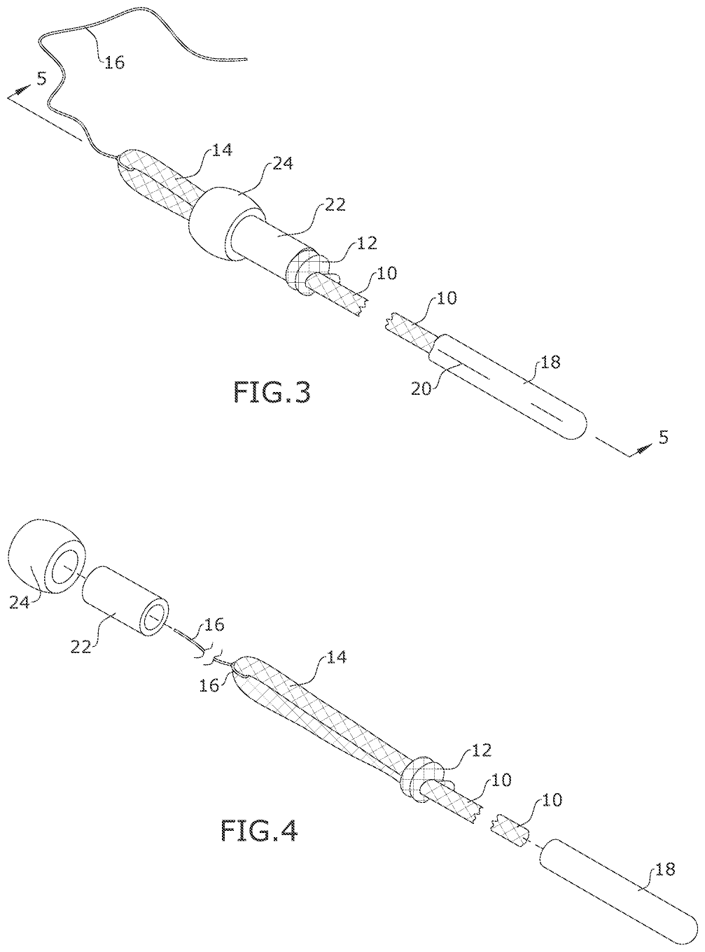

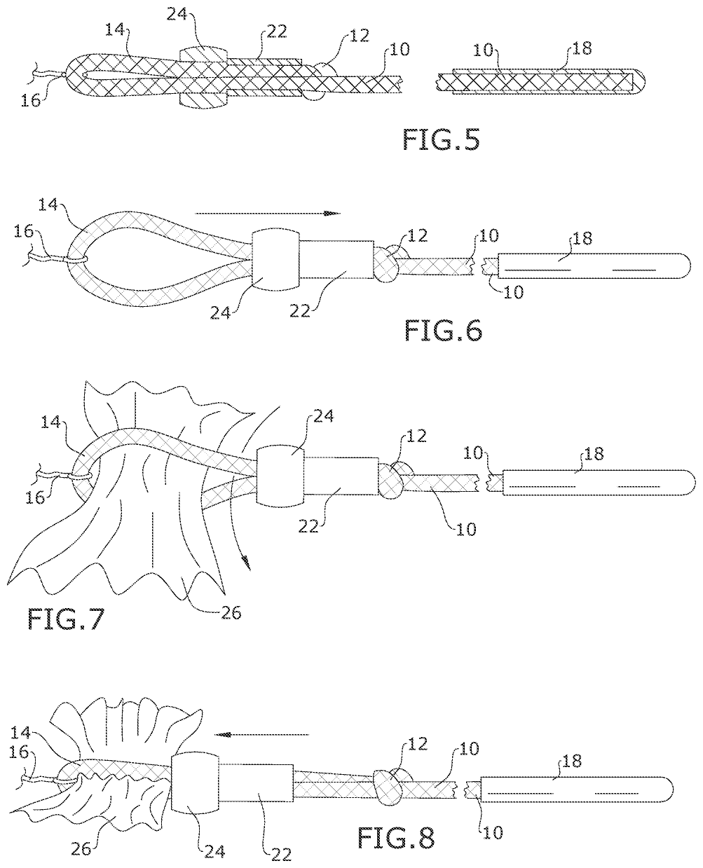

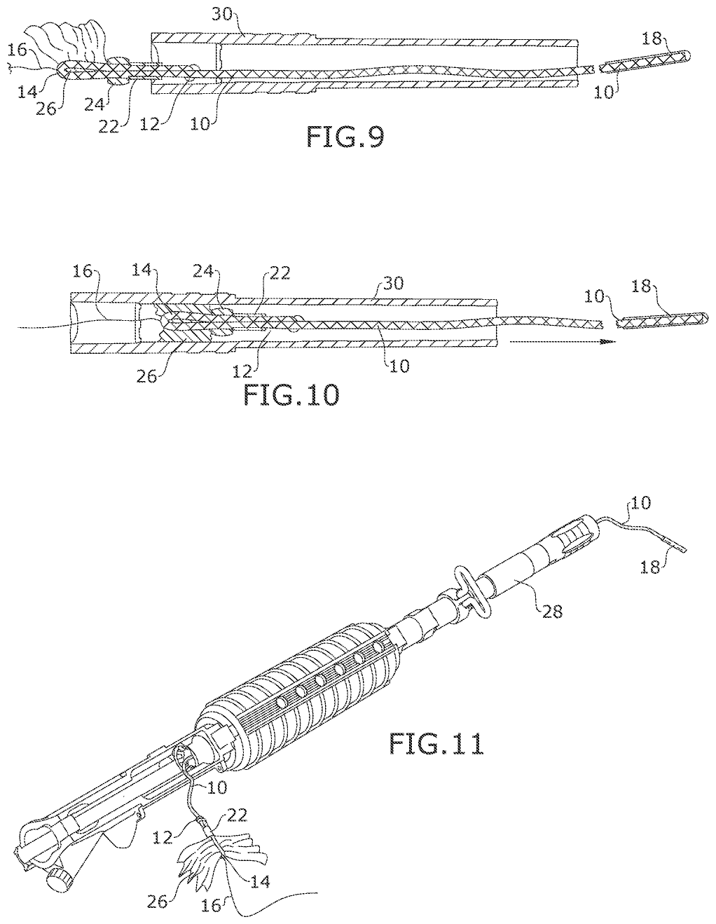

We claim:

1. An apparatus for cleaning a bore of a firearm comprising of an adjustable loop, length of braided twine, knot, sleeve, bead, cleaning patches, aglet, and a second length of twine.

2. The apparatus for cleaning a bore of a firearm comprising of the adjustable loop, length of braided twine, knot, sleeve, bead, cleaning patches, aglet, and a second length of twine as in claim 1, wherein the braided twine has a length greater than the barrel of the firearm to be cleaned and a diameter less than the barrel of the firearm to be cleaned.

3. The apparatus for cleaning a bore of a firearm comprising of the adjustable loop, length of braided twine, knot, sleeve, bead, cleaning patches, aglet, and a second length of twine as in claim 1, wherein a knot is located at the distal end of the braided twine to create a loop.

4. The apparatus for cleaning a bore of a firearm comprising of the adjustable loop, length of braided twine, knot, sleeve, bead, cleaning patches, aglet, and a second length of twine as in claim 1, wherein the sleeve is carried by the adjustable loop.

5. The apparatus for cleaning a bore of a firearm comprising of the adjustable loop, length of braided twine, knot, sleeve, bead, cleaning patches, aglet, and a second length of twine as in claim 1, wherein the sleeve and bead cinch the loop about a cleaning patch.

6. The apparatus for cleaning a bore of a firearm comprising of the adjustable loop, length of braided twine, knot, sleeve, bead, cleaning patches, aglet, and a second length of twine as in claim 1, wherein the bead and sleeve are constructed from a rigid or semi-rigid material to prevent scratching.

7. The apparatus for cleaning a bore of a firearm comprising of the adjustable loop, length of braided twine, knot, sleeve, bead, cleaning patches, aglet, and a second length of twine as in claim 1, wherein the aglet is attached to the proximal end of the braided twine to provide weight and facilitate movement.

8. The apparatus for cleaning a bore of a firearm comprising of the adjustable loop, length of braided twine, knot, sleeve, bead, cleaning patches, aglet, and a second length of twine as in claim 1, wherein the aglet is constructed from a weighted material.

9. The apparatus for cleaning a bore of a firearm comprising of the adjustable loop, length of braided twine, knot, sleeve, bead, cleaning patches, aglet, and a second length of twine as in claim 1, wherein the second length of twine is attached to the distal end of the loop.

10. The apparatus for cleaning a bore of a firearm comprising of the adjustable loop, length of braided twine, knot, sleeve, bead, cleaning patches, aglet, and a second length of twine as in claim 1, wherein the second length of twine has a length of 10 inches to assist with extraction, if necessary.

11. A method for cleaning a bore of a firearm comprising of the adjustable loop, length of braided twine, knot, sleeve, bead, cleaning patches, aglet, and a second length of twine.

12. The method for cleaning a bore of a firearm comprising of the adjustable loop, length of braided twine, knot, sleeve, bead, cleaning patches, aglet, and a second length of twine as in claim 11, wherein the braided twine has a length greater than the barrel of the firearm to be cleaned and a diameter less than the barrel of the firearm to be cleaned.

13. The method for cleaning a bore of a firearm comprising of the adjustable loop, length of braided twine, knot, sleeve, bead, cleaning patches, aglet, and a second length of twine as in claim 11, wherein a knot is located at the distal end of the braided twine to create a loop.

14. The method for cleaning a bore of a firearm comprising of the adjustable loop, length of braided twine, knot, sleeve, bead, cleaning patches, aglet, and a second length of twine as in claim 11, wherein the sleeve is carried by the adjustable loop.

15. The method for cleaning a bore of a firearm comprising of the adjustable loop, length of braided twine, knot, sleeve, bead, cleaning patches, aglet, and a second length of twine as in claim 11, wherein the sleeve and bead cinch the loop about a cleaning patch.

16. The method for cleaning a bore of a firearm comprising of the adjustable loop, length of braided twine, knot, sleeve, bead, cleaning patches, aglet, and a second length of twine as in claim 11, wherein the bead and sleeve are constructed from a rigid or semi-rigid material to prevent scratching.

17. The method for cleaning a bore of a firearm comprising of the adjustable loop, length of braided twine, knot, sleeve, bead, cleaning patches, aglet, and a second length of twine as in claim 11, wherein the aglet is attached to the proximal end of the braided twine to provide weight and facilitate movement.

18. The method for cleaning a bore of a firearm comprising of the adjustable loop, length of braided twine, knot, sleeve, bead, cleaning patches, aglet, and a second length of twine as in claim 11, wherein the aglet is constructed from a weighted material.

19. The method for cleaning a bore of a firearm comprising of the adjustable loop, length of braided twine, knot, sleeve, bead, cleaning patches, aglet, and a second length of twine as in claim 11, wherein the second length of twine is attached to the distal end of the loop.

20. The method for cleaning a bore of a firearm comprising of the adjustable loop, length of braided twine, knot, sleeve, bead, cleaning patches, aglet, and a second length of twine as in claim 11, wherein the second length of twine has a length of 10 inches to assist with extraction, if necessary.
